(19) United States
(12) Patent Application Publication
(10) Pub. No.: US 2010/0054210 A1
(43) Pub. Date: Mar. 4, 2010

(54) WIRELESS NETWORK TRANSITIONING FOR MOBILE DEVICES

(75) Inventor: Mattias OSTERGREN, Lund (SE)

Correspondence Address: HARRITY & HARRITY, LLP, 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 12/202,750

(22) Filed: Sep. 2, 2008

(51) Int. Cl. H04W 4/00

(52) U.S. Cl. 370/332

(57) ABSTRACT

A mobile device and method are provided for receiving a measured signal strength associated with a second network at a first point in time. The processor calculates a predicted signal strength associated with the second network at a second point in time based on the measured signal strength and makes a determination regarding whether the quality of the second network is good and a determination regarding whether the quality of the second network is bad based on the measured signal strength and the predicted signal strength. The processor determines whether to rove in or rove out of the second network based on the determination regarding whether the quality of the network is good and the determination regarding whether the quality of the network is bad.

### BACKGROUND

1. Technical Field of the Invention

Implementations described herein relate generally to mobile devices and, more particularly, to systems and methods for efficiently transitioning between different types of communications networks used by the mobile devices.

2. Description of Related Art

Traditionally, mobile devices operate using a single type of wireless network protocol, such as GSM (Global System for Mobile communication), CDMA (code division multiple access), or TDMA (time division multiple access) cellular telephone networks, or IEEE 802.11x (WiFi), or Wi-Max wireless data networks. With the increasing ubiquity of typically localized wireless networks, mobile device manufacturers are providing mobile devices that can operate on more than one of these types of networks. For example, a mobile device may be provided with both GSM and WiFi radios to facilitate communication with both GSM and WiFi networks. Such mobile devices are often referred to as UMA(Unlicensed Mobile Access)/GAN(Generic Access Network) devices.

Unfortunately, for existing UMA/GAN devices, communications via each type of network are typically limited to the network selected or used during the initialization of the instant communication (e.g., a phone call) or specified for use by particular applications or functions. For example, some devices may support GSM for voice communication and SMS (short message system) messages, and WiFi for Internet browsing. In other instances, the UMA/GAN device may support an initial network determination, but may be unable to adequately transition to a more suitable network, should one become available. In these instances, although, during the course of the communication, another, more robust or reliable network may have become available, the mobile device is typically unable to transition to the other network without disrupting communication (e.g., dropping the call). One reason for this failure is the inability of the mobile device to accurately and rapidly ascertain the existence and quality of a newly available network.

### SUMMARY

According to one aspect, a method may include measuring a signal strength associated with a network at a first point in time; calculating a predicted signal strength associated with the network at a second point in time based on the measurement; determining whether a quality of the network is good based on the signal strength at the first point in time and the predicted signal strength at the second point in time; determining whether the quality of the network is bad based on the signal strength at the first point in time and the predicted signal strength at the second point in time; and determining whether to rove in or rove out of the network based on the determining whether the quality of the network is good and the determining whether the quality of the network is bad.

Additionally, the network may be a wireless network.

Additionally, the wireless network may be a wireless local area network (LAN).

Additionally, measuring a signal strength associated with a network at a first point in time may include measuring a received signal strength indicator (RSSI) associated with the network.

Additionally, calculating the predicted signal strength associated with the network at a second point in time may include calculating the predicted signal strength based on the measured signal strength and a previously measured signal strength.

Additionally, the previously measured signal strength may include a signal strength measured at a point in time preceding the first point in time.

Additionally, a time interval between the first point in time and the point in time preceding the first point in time may be between 220 milliseconds (ms) and 1 second (s).

Additionally, the predicted signal strength may be calculated by: predicted signal strength=2*current signal strength−previous signal strength, where the current signal strength comprises the measured signal strength and the previous signal strength comprises the previously measured signal strength.

Additionally, the method may include calculating an error margin associated with the predicted signal strength; and determining whether the quality of the network is good is based on the measured signal strength, the predicted signal strength at the second point in time, and the error margin.

Additionally, calculating the error margin may include determining a highest signal strength in a predetermined number of previously measured signal strengths; determining a lowest signal strength in a predetermined number of previously measured signal strengths; and calculating the error margin based on a difference between the highest signal strength and the lowest signal strength.

Additionally, the predetermined number of previously measured signal strengths may be four.

Additionally, determining whether the quality of the network is good may include determining whether the measured signal strength is greater than a first predetermined threshold; determining whether the predicted signal strength is greater than the first predetermined threshold; determining whether the calculated error margin is less than a second predetermined threshold; determining that the quality of the network is good when the measured signal strength is greater than the first predetermined threshold, the predicted signal strength is greater than the first predetermined threshold, and the calculated error margin is less than the second predetermined threshold; and determining that the quality of the network is not good when the measured signal strength is not greater than the first predetermined threshold, the predicted signal strength is not greater than the first predetermined threshold, or the calculated error margin is not less than the second predetermined threshold.

Additionally, the method may include calculating a difference value based on the measured signal strength and a previously measured signal strength; and determining whether the quality of the network is bad is based on the predicted signal strength at the second point in time, and the difference value.

Additionally, determining whether the quality of the network is bad may include determining whether the predicted signal strength is less than a third predetermined threshold; determining whether the calculated difference value is less than a fourth predetermined threshold; determining that the quality of the network is bad when the predicted signal strength is less than the third predetermined threshold, and the calculated difference value is less than the fourth predetermined threshold; and determining that the quality of the network is not bad when the predicted signal strength is not less than the third predetermined threshold, or the calculated difference value is not less than the fourth predetermined threshold.

Additionally, the method may include determining whether a device is currently communicating via the network; maintaining device communications via the network when it is determined to rove in and when the device is currently communicating via the network; transitioning device communications to the network when it is determined to rove in and when the device is not currently communicating via the network; maintaining device communications via a different network when it is determined to rove out and when the device is not currently communicating via the network; and transitioning device communications to the different network when it is determined to rove out and when the device is currently communicating via the network.

Additionally, the network may include a wireless local area network and the different network may include a cellular-based wireless network.

In a second aspect, a mobile device may include a first wireless transceiver for communicating via a first network; a second wireless transceiver for communicating via a second network; sensor logic for measuring a signal strength associated with the second network; and a processor. The processor may be configured to receive the measured signal strength associated with a second network at a first point in time; calculate a predicted signal strength associated with the second network at a second point in time based on the measured signal strength; determine whether a quality of the second network is good based on the measured signal strength and the predicted signal strength; determine whether the quality of the second network is bad based on the measured signal strength and the predicted signal strength; and determine whether to rove in or rove out of the second network based on the determination regarding whether the quality of the second network is good and the determination regarding whether the quality of the second network is bad.

Additionally, the processor may be further configured to determine whether the device is currently communicating via the second wireless transceiver or the first wireless transceiver; maintain device communications via the second wireless transceiver when it is determined to rove in and when the device is currently communicating via the second wireless transceiver; transition device communications from the first wireless transceiver to the second wireless transceiver when it is determined to rove in and when the device is currently communicating via the first wireless transceiver; maintain device communications via the first wireless transceiver when it is determined to rove out and when the device is currently communicating via the first wireless transceiver; and transition device communications to the first wireless transceiver when it is determined to rove out and when the device is currently communicating via the second wireless transceiver.

Additionally, the processor may be further configured to calculate an error margin associated with the predicted signal strength; and determine whether the quality of the network is good is based on the measured signal strength, the predicted signal strength, and the error margin.

In a third aspect, a computer-readable memory device may include instructions for facilitating transition between a first network and a second network. The instructions may include instructions for measuring a signal strength associated with the second network at a first point in time; instructions for calculating a predicted signal strength associated with the second network at a second point in time based on the measurement; instructions for determining whether a quality of the second network is good based on the measured signal strength at the first point in time and the predicted signal strength at the second point in time; instructions for determining whether the quality of the second network is bad based on the measured signal strength at the first point in time and the predicted signal strength at the second point in time; instructions for determining whether to communicate via the second network based on the determining whether the quality of the network is good and the determining whether the quality of the second network is bad; and transitioning communications into or out of the second network based the determination to communicate via the second network.

### BRIEF DESCRIPTION OF THE DRAWINGS

The accompanying drawings, which are incorporated in and constitute a part of this specification, illustrate an embodiment of the invention and, together with the description, explain the invention. In the drawings,

FIG. 1 is a diagram of an exemplary system in which systems and methods described below may be implemented;

FIG. 2 is a diagram of an exemplary mobile device of FIG. 1; and

FIGS. 3-6 are flowcharts of an exemplary process for facilitating transition of the mobile device of FIG. 1 between the first network and the second network.

### DETAILED DESCRIPTION OF EMBODIMENTS

The following detailed description of the invention refers to the accompanying drawings. The same reference numbers in different drawings may identify the same or similar elements. Also, the following detailed description does not limit the invention.

A system and a method are described for facilitating transitioning between a first wireless network and second wireless network. Moreover, the system and method may actively determine a quality of an available wireless network in the context of multiple criteria to provide an accurate and efficient mechanism for determining when to rove in or rove out of the wireless network. More specifically, a predicted signal strength measurement, prior signal strength measurements, and predetermined thresholds may be used to accurately determine when to rove in or out of a wireless network.

### Exemplary System

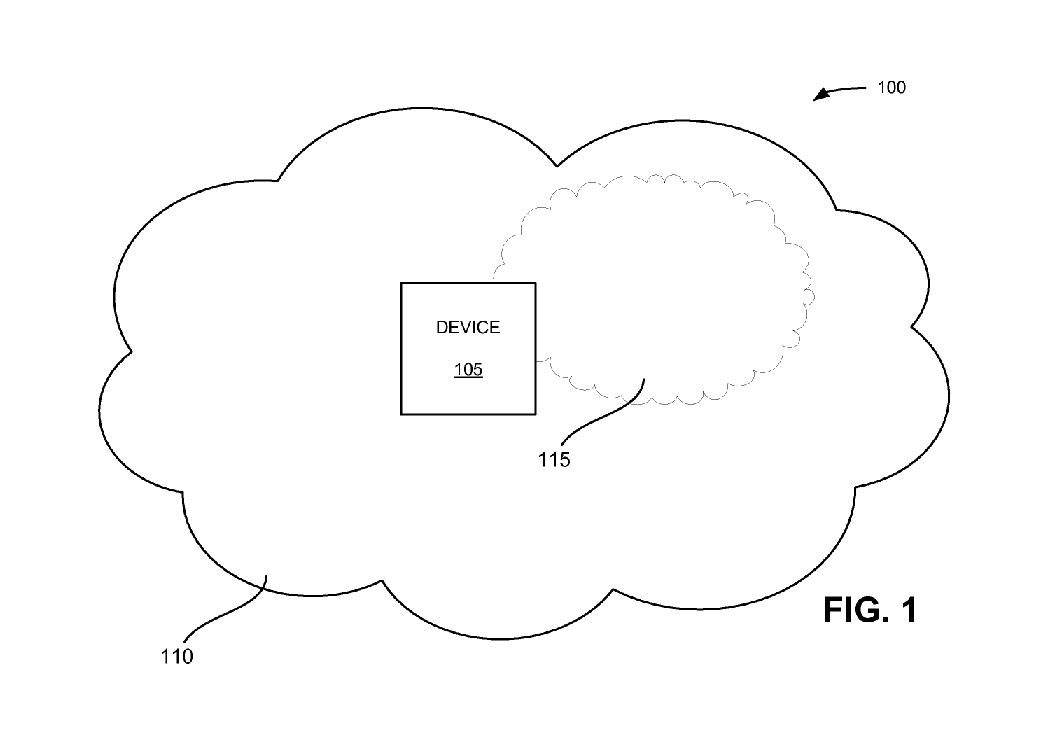

FIG. 1 is a diagram of an exemplary system 100 in which systems and methods described herein may be implemented. As illustrated in FIG. 1, system 100 may include mobile device 105, first wireless network 110, and second wireless network 115. Mobile device 105 may include any of a variety of electronic devices such as cellular radiotelephones; Personal Communications System (PCS) devices that may combine a cellular radiotelephone with data processing, facsimile and data communications capabilities; Personal Digital Assistants (PDAs); laptop and/or palmtop computers; personal or portable media players, such as digital music and/or video players; and/or other similar types of devices. Mobile device 105 may include components and features commensurate with their respective functions.

In addition, mobile device 105 may be configured to access each of first wireless network 110 and second wireless network 115. Examples of first wireless network 110 may include GSM, CDMA, or TDMA cellular networks, while examples of second wireless network 115 may include WiFi or Wi-max-based wireless data networks.

In one implementation described below, mobile device 105 may accurately and efficiently identify the suitability and stability of second network 115 in order to determine whether to transition communications from first network 110 to second network 115 (also referred to hereinafter “rove in”) or to transition from second network 115 to first network 110 (also referred to hereinafter “rove out”).

### Exemplary Mobile Device Configuration

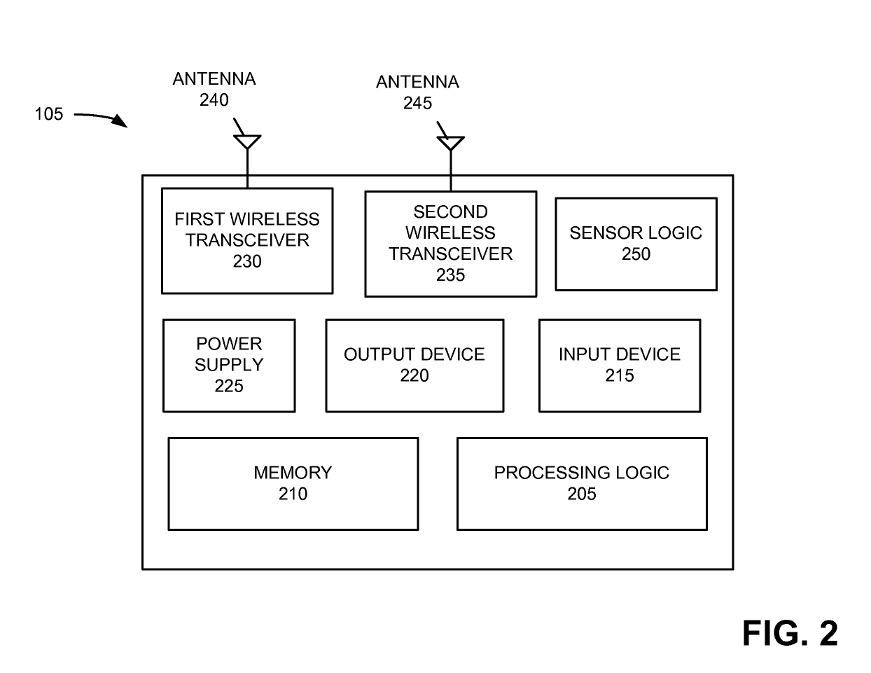

FIG. 2 is a diagram illustrating exemplary components of mobile device 105. As illustrated in FIG. 2, mobile device 105 may include processing logic 205, a memory 210, input device 215, output device 220, power supply 225, first wireless transceiver 230, second wireless transceiver 235, antennas 240 and 245, and sensor logic 250. It will be appreciated that mobile device 105 may include other components (not shown) that aid in receiving, transmitting, and/or processing data. Moreover, it will be appreciated that other configurations are possible.

Processing logic 205 may include any type of processor, microprocessor, or combinations of processors that may interpret and execute instructions. In other implementations, processing logic 205 may be implemented as or include one or more application specific integrated circuits (ASICs), field programmable gate arrays (FPGAs), or the like. Memory 210 may include a random access memory (RAM) or another type of dynamic storage device that may store information and instructions for execution by processing logic 205, a read only memory (ROM) or another type of static storage device that may store static information and instructions for the processing logic 205, and/or some other type of magnetic or optical recording medium and its corresponding drive for storing information and/or instructions.

Consistent with aspects described herein, memory 210 may include applications and drivers suitable for enabling the configuration of first wireless transceiver 230 and second wireless transceiver 235 as well as applications and/or drivers for enabling usage of first wireless transceiver 230 and second wireless transceiver 235 and communications transitioning therebetween. Exemplary applications may include mobile communications such as voice calling, text messaging, instant messaging, data (e.g., Internet) sessions, etc. Suitable drivers for implementing these applications via first wireless transceiver 230 and second wireless transceiver 235 may be provided.

Input device 215 may include a device that permits a user to input information to mobile device 105, such as an interface port, a keypad, a keyboard, a mouse, a pen, a microphone, a touch screen, one or more biometric mechanisms, and the like. Output device 220 may include a device that outputs information to the user, such as a display, a printer, a speaker, etc. Power supply 225 may include a battery or AC power adapter, or the like, for providing power to the components of mobile device 105.

First wireless transceiver 230 may include a transceiver device capable of transmitting and receiving data and control signals using a first cellular or long distance-based wireless communications protocol such as a cellular radiotelephone protocol (e.g., GSM, PCS (personal communication services), FDMA (frequency division multiple access), CDMA, TDMA, etc.).

Second wireless transceiver 235 may include a transceiver device capable of transmitting and receiving data and control signals using a second, short distance wireless communication protocols such as the Bluetooth protocol, one or more of the IEEE 802.11 (i.e., WiFi or Wireless LAN (local area network)) protocols, the WiMax protocol, the Ultra Wideband protocol, or any other suitable wireless communication protocol. Antennas 240 and 245 may include, for example, one or more directional antennas and/or omni directional antennas suitable for facilitating transmitting and/or receiving data via the first and second wireless transceivers 230/235.

Sensor logic 250 may be associated with second wireless transceiver 235 and may include any combination of hardware and software capable of monitoring one or more signals being received via second wireless transceiver 235. For example, sensor logic 250 may include logic for monitoring a predetermined band of the radio frequency (RF) spectrum and may generate a value corresponding to the strength of the monitored signals as well as an identifier associated with each monitored signal. In one implementation, the monitored strength values may be measured in terms of decibel milliwatts (dBm's).

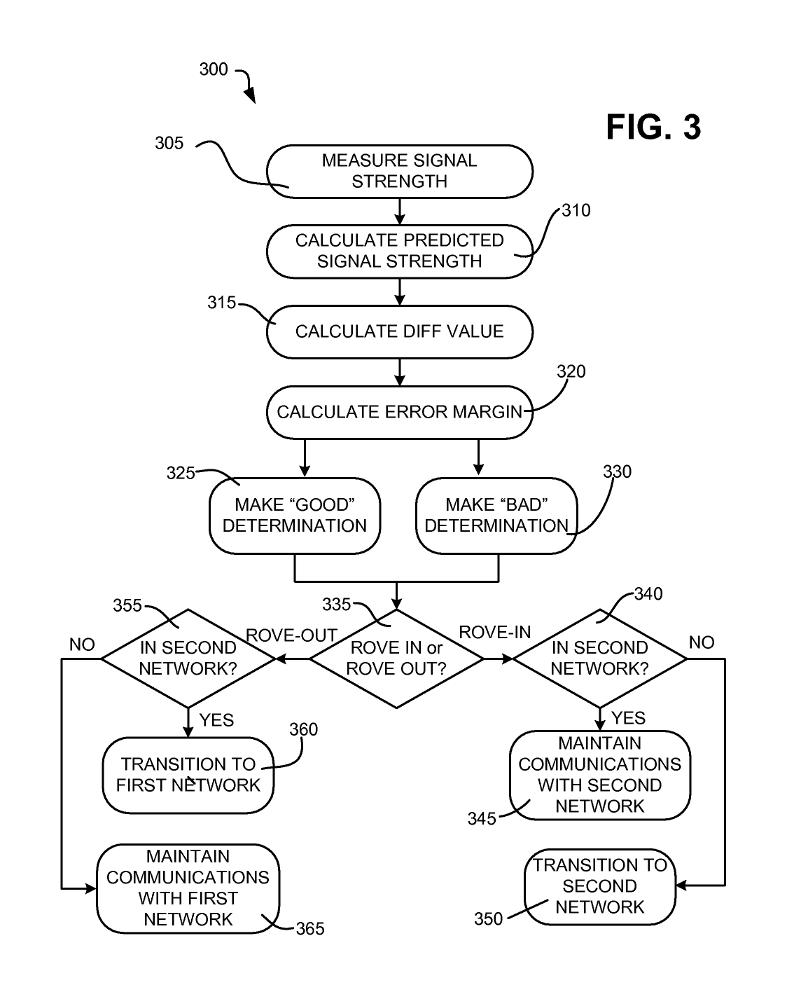

As will be described in detail below, mobile device 105 may include functionality, e.g., using processing logic 205, for transitioning communications between first network 110, via first wireless transceiver 230 and second network 115, via second wireless transceiver 235. In order to ensure that such transitions are not made prematurely or too rapidly (e.g., resulting in a ping-pong effect between networks), processing logic 205 may determine, using the output of sensor logic 250 and calculations described in detail below with respect to FIGS. 3-6, whether the signal strength associated with an available second network 115 is sufficient to support or sustain high quality communications via second network 115. If second network 115 is not sufficient to either support a transition to second network 115 from first network 110 or to sustain communications on second network 115, processing logic 205 may either transition communications to first network 110 (if communications are currently passing via second network 115) or maintain the communications on first network 110 (if communications are currently passing via first network 110).

Mobile device 105 may perform these operations and other operations in response to processing logic 205 executing software instructions contained in a computer-readable medium, such as memory 210. A computer-readable medium may be defined as a physical or logical memory device.

The software instructions may be read into memory 210 from another computer-readable medium or from another device via, for example, first wireless transceiver 230, second wireless transceiver 235, or input device 215. The software instructions contained in memory 210 may cause processing logic 205 to perform processes that will be described later. Alternatively, hardwired circuitry may be used in place of or in combination with software instructions to implement processes consistent with the principles of the invention. Thus, implementations consistent with the principles of the invention are not limited to any specific combination of hardware circuitry and software.

### Exemplary Processing

FIGS. 3-6 are flowcharts of an exemplary process 300 for facilitating transition of mobile device 105 between first network 110 and second network 115. Processing may begin upon measuring a signal strength associated with second network 115 at a current point in time, via, e.g., sensor logic 250 (block 305). For example, at predetermined periodic intervals, e.g., within the range of 200 milliseconds (ms) to 1 second, sensor logic 250 may pass a measurement associated with second network 115 to processing logic 205. In one implementation, second wireless network 115 may include a WiFi-based wireless LAN and the measurement may include a received signal strength indication (RSSI) measurement.

Once a current signal strength measurement is made, a predicted value for the signal strength measurement at the next period in time may be calculated (block 310). For example, a difference value (diff) may be calculated that indicates the absolute value of the difference between the current signal strength measurement and the signal strength measurement at the preceding moment in time (block 315). Next, an error margin associated with the predicted signal strength measurement may be calculated (block 320).

In one implementation, previous signal strength measurements may be used to predict the signal strength measurement at the next period in time. In one exemplary implementation, the predicted signal strength measurement (nextRSSI) may be defined as:

nextRSSI=2*currentRSSI−previousRSSI,

where the previousRSSI refers to the signal strength measurement at the period of time immediately preceding the current period of time. In one implementation, the diff value may be defined as:

diff=ABS(RSSI−previousRSSI),

where ABS represents an absolute value. The calculated diff value may be used in subsequent processing to assist in determining whether a quality associated with second network 115 is bad.

The error margin calculated for the predicted signal strength measurement may, for example, be based on the previous N signal strength measurements, where N is a predetermined integer value. The error margin represents the degree of fluctuation in the monitored signal over a predetermined timeframe. In one exemplary implementation, N may be set to 4, such that the previous 4 signal strength measurement values may be used to determine the error margin associated with the predicted signal strength measurement value. In this implementation, the lowest of the previous N signal strength measurements may be determined to be the minimum signal strength value and the highest of the previous N signal strength measurements may be determined to be the maximum signal strength value. The calculated error margin may be based on the calculated minimum signal strength (e.g., of the previous 4 measurements) and the maximum signal strength (e.g., of the previous 4 measurements). In one exemplary implementation, the error margin may be defined as:

signal strength error margin=maximum signal strength−minimum signal strength.

In one exemplary implementation, the determination of predicted value for the signal strength measurement at the next period in time (block 310), the diff value (block 315), and the error margin associated with the predicted signal strength measurement (block 320) may be represented in the following pseudo-code:

```
On periodic Update(RSSI):
  estimatedNextRSSI = 2 * RSSI − previousRSSI
  diff = ABS(RSSI − previousRSSI)
  min = previousRSSI
  max = previousRSSI
for each of the previously N number of previous RSSI values
    if previous RSSI value I < min then
        min = previous RSSI value I
    if previous RSSI value I > max then
        max = previous RSSI value I
minMaxDiff = max − min,
```

where RSSI refers to the current signal strength measurement, estimatedNEXTRSSI refers to the predicted signal strength measurement, previous RSSI refers to the signal strength measurement at the preceding point in time, diff refers to the difference value, N is any suitable and efficient integer value (e.g., 4), I is an incremented counter variable from 1 to N, min refers to the minimum measured signal strength in the previous N measurements, max refers to the minimum measured signal strength in the previous N measurements , and minMaxDiff refers to the error margin between max and min.

Once the predicted value for the signal strength measurement at the next period in time and the signal strength error margin have been calculated, it may be determined whether the quality of second network 115 is “good” (block 325). It may also be determined whether the quality of second network 115 is “bad” (block 330).

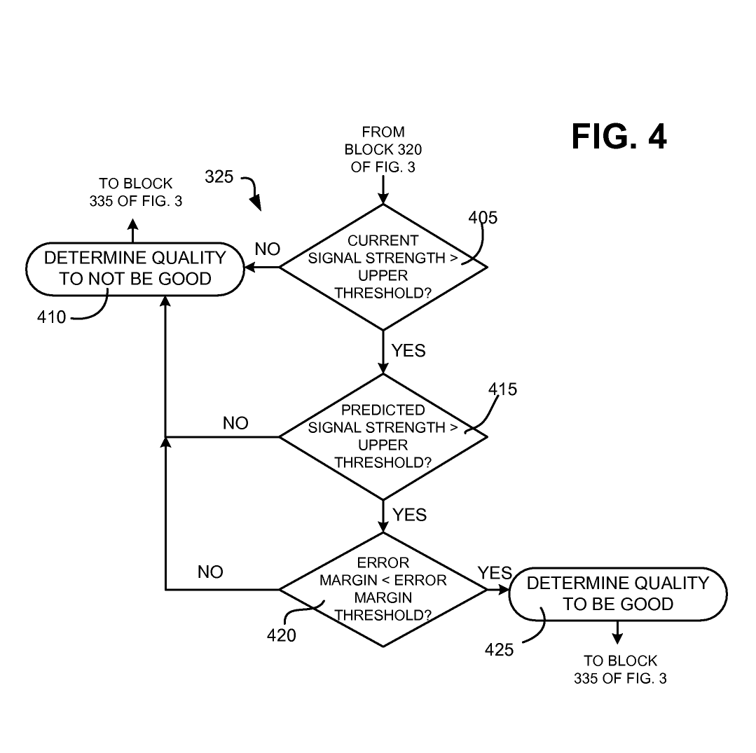

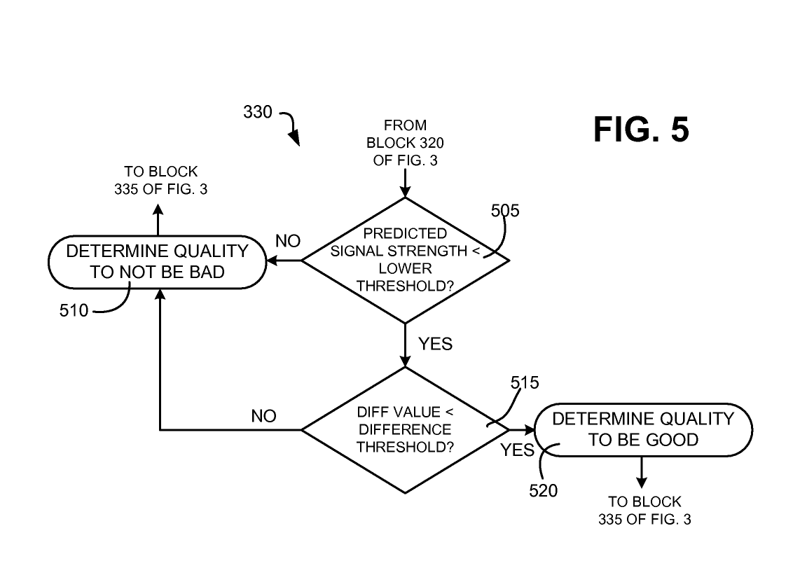

As used herein, the term “good,” in relation to the quality of second network 115, may be defined to include a quality sufficient to support the transition of communications from first network 110 to second network 115. The term “bad,” in relation to the quality of second network 115, may be defined to indicate that the quality of second network 115 is not sufficient to support communications and that communications should either not be transitioned to second network 115 from first network 110, or existing communications on second network 115 should be transitioned to first network 110. For clarification purposes, it should be noted that determinations regarding a “goodness” of second network 115 and a “badness” of second network 115 are not mutually exclusive in that second network may be found to be not good and not bad simultaneously, in the manner described below. Additional details relating to the “good” determination and the “bad” determination are set forth below in FIGS. 4 and 5, respectively.

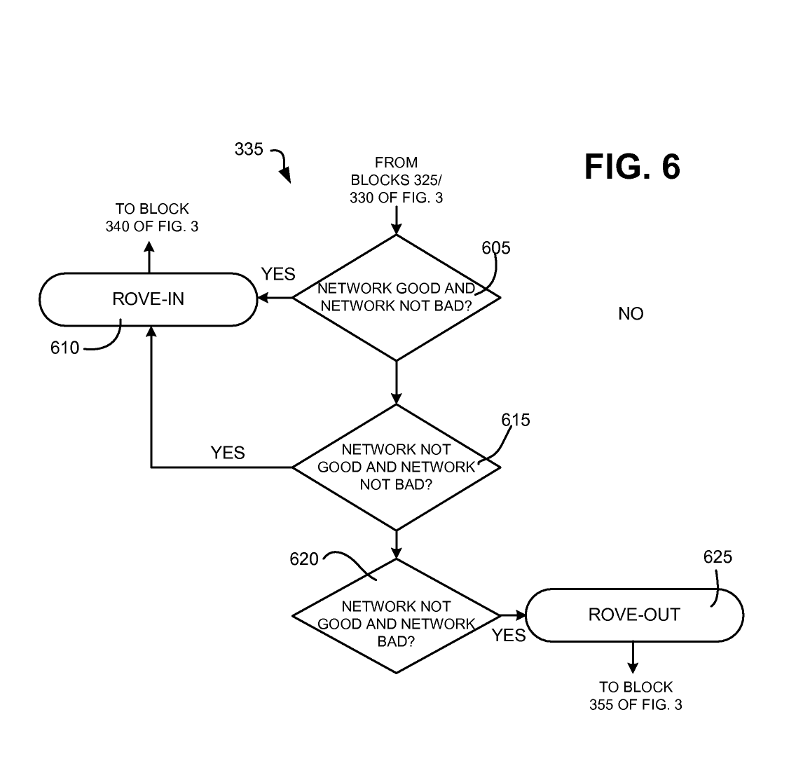

Once the “good” determination and the “bad” determination have been made, it may be determined whether device 105 should “rove in” to (or stay in) second network 115 or whether device 105 should “rove out” (or stay out) of second network 115 based on the “good” and “bad” determinations (block 335). Additional details relating to the determination of whether the “rove in” or “rove out” are set forth below in FIG. 6.

If it is determined to “rove in” (block 335—Rove In), it may be determined whether device 105 is currently communicating via second network 115 (block 340). In other words, it may be determined whether device 105 has previously roved in to second network 115. If it is determined that device 105 is currently communicating via second network 115 (block 340—YES), device 105 may maintain communications via second wireless transceiver 235 (block 345). However, if it is determined that device 105 is not currently communicating via second network 115 (block 340—NO), e.g., that device 105 is currently communicating via first network 110, device 105 may transition current and/or future communications from first wireless transceiver 230 to second wireless transceiver 235 (block 350).

Returning to block 335, if it is determined to “rove out” (block 335—Rove Out), it may be determined whether device 105 is currently communicating via second network 115 (block 355). If it is determined that device 105 is currently communicating via second network 115 (block 355—YES), device 105 may transition current and/or future communications from second wireless transceiver 235 to first wireless transceiver 230 (block 360). However, if it is determined that device 105 is not currently communicating via second network 115 (block 355—NO), e.g., that device 105 is currently communicating via first network 110, device 105 may maintain communications via first wireless transceiver 230 (block 365).

In one exemplary implementation, the determination of whether the quality of second network 115 is “good” may be based on the predicted value for the signal strength measurement at the next period in time (nextRSSI), the signal strength error margin, a predetermined upper signal strength threshold, and a predetermined error margin threshold. For example, process block 325 of FIG. 3 may, in one implementation, include the process blocks depicted in FIG. 4 and described below.

As shown in FIG. 4, process block 405 may include determining whether the current signal strength value is greater than the upper signal strength threshold. For example, the upper signal strength threshold may include a signal strength value above which quality is typically high. One exemplary value of upper signal strength threshold may be approximately −70 dBm, although suitable variations to this threshold may be made based on the requirements associated with second wireless transceiver 235 and/or other components of mobile device 105 or second wireless network 115.

If it is determined that the current signal strength value is not greater than the upper signal strength threshold (block 405—NO), the quality of second network 115 is not determined to be good (block 410). However, if it is determined that the current signal strength value is greater than the upper signal strength threshold (block 405—YES), it may be determined whether the predicted signal strength measurement is greater than the upper signal strength threshold (block 415). If it is determined that the predicted signal strength measurement is not greater than the upper signal strength threshold (block 415—NO), processing may proceed to block 410, where the quality of second network 115 is not determined to be good.

However, if it is determined that the predicted signal strength measurement is greater than the upper signal strength threshold (block 415—YES), it may be determined whether the signal strength error margin is less than the error margin threshold (block 420). One exemplary value of error margin threshold may be approximately 3 dBm, although suitable variations to this threshold may be made based on the requirements associated with second wireless transceiver 235. In this exemplary implementation, an error margin threshold of 3 dBm indicates that fluctuations of less than 3 dBm over the predetermined timeframe (e.g., the last 4 measurements) may be indications that the quality of second network 115 is high, whereas fluctuations of more than (or exactly) 3 dBm over the predetermined timeframe may be indications that the quality of second network 115 is low or bad.

If it is determined that the signal strength error margin is less than the error margin threshold (block 420—YES), it may be determined that the quality of second network 115 is good (block 425). However, it is determined that the signal strength error margin is less than the error margin threshold (block 420—NO), processing may proceed to block 410, where the quality of second network 115 is not determined to be good.

In one exemplary implementation, the determination of whether the signal strength of network 115 is good may be represented in the following pseudo-code:

```
If RSSI > RSSI_THRESHOLD_HI and
  estimatedNextRSSI > RSSI_THRESHOLD_HI and
  minMaxDiff < MIN_MAX_DIFF_TRESHOLD then
  qualityGood = TRUE
else
  qualityGood = FALSE
end if
```

where RSSI_THRESHOLD_HI refers to the upper signal strength threshold, MIN_MAX_DIFF_THRESHOLD refers to the error margin threshold, qualityGood is a binary variable (True or False) representing the final determination of whether the signal strength of network 115 is good.

In one exemplary implementation, the determination of whether the quality of second network 115 is “bad” may be based on the predicted value for the signal strength measurement at the next period in time (nextRSSI), the difference value (diff) between the current signal strength value and the immediately previous measured signal strength value, a predetermined lower signal strength threshold, and a predetermined difference threshold. For example, process block 330 of FIG. 3 may, in one implementation, include the process blocks depicted in FIG. 5 and described below.

As shown in FIG. 5, process block 505 may include determining whether the current signal strength value is less than the lower signal strength threshold. For example, the lower signal strength threshold may include a signal strength value below which quality is typically poor. One exemplary value of a lower signal strength threshold may be approximately −84 dBm, although suitable variations to this threshold may be made based on the requirements associated with second wireless transceiver 235. Furthermore, it should be noted that the lower signal strength threshold should be lower than the upper signal strength threshold described above in relation to FIG. 4.

If it is determined that the predicted signal strength measurement is not less than the lower signal strength threshold (block 505—NO), the quality of second network 115 is not determined to be bad (block 510). However, if it is determined that the predicted signal strength value is lower than the lower signal strength threshold (block 505—YES), it may be determined whether the calculated difference value (diff) is less than the difference threshold (block 515).

One exemplary value of difference threshold may be approximately 8 dBm, although suitable variations to this threshold may be made based on the requirements associated with second wireless transceiver 235 and/or other components of mobile device 105. In this exemplary implementation, a difference threshold of 8 dBm indicates that a difference between the current signal strength value and the immediately previous measured signal strength value of less than 8 dBm (e.g., that the two measurements are relatively close) indicates that the predicted signal strength measurement is reliable and may be used as a basis for the “bad” determination, whereas a diff value of more than (or exactly) 8 dBm may indicate that the predicted signal strength measurement is not reliable.

If it is determined that the calculated diff value is less than the difference threshold (block 515—YES), it may be determined that the quality of second network 115 is bad (block 520). However, if it is determined that the calculated diff value is not less than the difference threshold (block 515—NO), processing may proceed to block 510, where the quality of second network 115 is not determined to be bad.

In one exemplary implementation, the determination of whether the signal strength of network 115 is bad may be represented in the following pseudo-code:

```
If estimatedNextRSSI < RSSI_THRESHOLD_LO and
  Diff < DIFF_THRESHOLD then
  qualityBad = TRUE
else
  qualityBad = FALSE
end if
```

where RSSI_THRESHOLD_LO refers to the lower signal strength threshold, DIFF_THRESHOLD refers to the difference threshold, and qualityBad is a binary variable (True or False) representing the final determination of whether the signal strength of network 115 is bad.

In one exemplary implementation, the determination of whether to “rove in” or “rove out” of second network 115 may be based on the “good” determination of block 325 and the “bad” determination of block 330. For example, process block 335 of FIG. 3 may, in one implementation, include the process blocks depicted in FIG. 6 and described below.

As shown in FIG. 6, process block 605 may include determining whether the quality of wireless network 115 is “good” (from block 325) and the quality of wireless network 115 is not “bad” (from block 330). If so (block 605—YES), it may be determined to “rove in” (block 610). However, if it is not determined that the quality of wireless network 115 is “good” (from block 325) and the quality of wireless network 115 is not “bad” (from block 330) (block 605—NO), it may be determined whether the quality of wireless network 115 is not “good” (from block 325) and the quality of wireless network 115 is not “bad” (from block 330) (block 615). If so (block 615—YES), processing may proceed to block 610 where the determination is made to “rove in.” In this instance, although the quality of second wireless network has not been determined to be “good,” the quality has also not been determined to be “bad” and therefore, depending on a specific implementation it may be determined that second wireless network is suitable for maintaining or supporting communications.

However, if it is not determined that the quality of wireless network 115 is not “good” (from block 325) and the quality of wireless network 115 is not “bad” (from block 330) (block 615—NO), it may be determined whether the quality of wireless network 115 is not “good” (from block 325) and the quality of wireless network 115 is “bad” (from block 330) (block 620). If so (block 620—YES), it may be determined to “rove out” (block 625). It should be noted that, in the exemplary implementation described above, because of the requirements relating to the above-described threshold values and the determinations of “good” and “bad,” it is not possible for the quality of wireless network 115 to be both “good” and “bad” simultaneously. Therefore, no processing option is presented in this regard in this implementation.

In one exemplary implementation, the determination of whether to “rove-in” or “rove-out” of network 115 may be represented in the following pseudo-code:

```
If qualityGood = TRUE and qualityBad = FALSE or
  qualityGood = FALSE and qualityBad = FALSE then
  Rove = in
else
  if qualityGood = FALSE and qualityBad = TRUE then
      Rove = out
  end if
end if
if Rove <> PreviousRoveAction then
  if Rove = In then
    Perform rove in
  Else
      If rove = Out then
        Perform rove out
      End if
    End if
    PreviousRoveAction = Rove
End if
```

where Rove is a binary variable (in or out) representing whether network 115 is suitable to carry communications to/from mobile device 105, and PreviousRoveAction refers to a current network being used by mobile device 105.

By providing a methodology and system for actively determining a quality of an available wireless network in the context of multiple criteria, an accurate and efficient mechanism may provided for determining when to rove in or rove out of the wireless network. More specifically, a predicted signal strength measurement, prior signal strength measurements, and/or predetermined thresholds may be used to accurately determine when to rove in or out of a wireless network. In this manner, a mobile device may transition to potentially cheaper networks with a high degree of confidence that the communication transition will happen seamlessly and with little impact on a user.

### Conclusion

Implementations described herein may provide a system and method for facilitating transitions between wireless networks. In one implementation, a signal strength of one of the wireless networks may be measured at predetermined intervals. Determinations regarding whether the wireless network is “good” or “bad” may be made based on the measurements as well as predicted future measurements and predetermined threshold values. Based on the “good” and “bad” determinations, a decision may be made to rove in or rove out of the wireless network.

The foregoing description of preferred embodiments of the invention provides illustration and description, but is not intended to be exhaustive or to limit the invention to the precise form disclosed. Modifications and variations are possible in light of the above teachings or may be acquired from practice of the invention.

For example, while the description above focuses on transitioning between cellular-based wireless networks and data-based wireless networks (such as WiFi-based wireless LANs, etc.), it will be appreciated that the above-described systems and methods may be used in conjunction with any suitable network, such as wired (e.g., Ethernet, Gigabit Ethernet, etc.) networks, Bluetooth® networks, infrared networks, or other RF-based or other wireless networking protocols.

While series of acts have been described with regard to FIGS. 3-6, the order of the acts may be modified in other implementations consistent with the principles of the invention. Further, non-dependent acts may be performed in parallel. For example, with respect to FIG. 3, the calculation of the predicted signal strength, the difference value, and the error margin may be performed in any suitable order or in parallel. Similarly, the “good” and “bad” determinations may also be performed in any suitable order or in parallel. In some implementations, these determinations may be made in a relative, continuous manner.

It will be apparent to one of ordinary skill in the art that aspects of the invention, as described above, may be implemented in many different forms of software, firmware, and hardware in the implementations illustrated in the figures. The actual software code or specialized control hardware used to implement aspects consistent with the principles of the invention is not limiting of the invention. Thus, the operation and behavior of the aspects were described without reference to the specific software code—it being understood that one would be able to design software and control hardware to implement the aspects based on the description herein.

Further, certain portions of the invention may be implemented as “logic” that performs one or more functions. This logic may include hardware, such as a processor, a microprocessor, an application specific integrated circuit or a field programmable gate array, software, or a combination of hardware and software.

It should be emphasized that the term “comprises/comprising” when used in this specification is taken to specify the presence of stated features, integers, steps, or components, but does not preclude the presence or addition of one or more other features, integers, steps, components, or groups thereof.

No element, act, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A method, comprising:
measuring a signal strength associated with a network at a first point in time;
calculating a predicted signal strength associated with the network at a second point in time based on the measurement;
determining whether a quality of the network is good based on the signal strength at the first point in time and the predicted signal strength at the second point in time;
determining whether the quality of the network is bad based on the signal strength at the first point in time and the predicted signal strength at the second point in time; and
determining whether to rove in or rove out of the network based on the determining whether the quality of the network is good and the determining whether the quality of the network is bad.

2. The method of claim 1, where the network is a wireless network.

3. The method of claim 2, where the wireless network is a wireless local area network (LAN).

4. The method of claim 1, where measuring a signal strength associated with a network at the first point in time, comprises:
measuring a received signal strength indicator (RSSI) associated with the network.

5. The method of claim 1, where calculating the predicted signal strength associated with the network at a second point in time, further comprises:
calculating the predicted signal strength based on the measured signal strength and a previously measured signal strength.

6. The method of claim 5, where the previously measured signal strength comprises a signal strength measured at a point in time preceding the first point in time.

7. The method of claim 6, where a time interval between the first point in time and the point in time preceding the first point in time is between 220 milliseconds (ms) and 1 second (s).

8. The method of claim 5, where the predicted signal strength is calculated by:
predicted signal strength=2*current signal strength−previous signal strength,
where the current signal strength comprises the measured signal strength and the previous signal strength comprises the previously measured signal strength.

9. The method of claim 1, further comprising:
calculating an error margin associated with the predicted signal strength; and
determining whether the quality of the network is good is based on the measured signal strength, the predicted signal strength at the second point in time, and the error margin.

10. The method of claim 9, where calculating the error margin further comprises:
determining a highest signal strength in a predetermined number of previously measured signal strengths;
determining a lowest signal strength in a predetermined number of previously measured signal strengths; and
calculating the error margin based on a difference between the highest signal strength and the lowest signal strength.

11. The method of claim 10, where the predetermined number of previously measured signal strengths is four.

12. The method of claim 9, where determining whether the quality of the network is good further comprises:
determining whether the measured signal strength is greater than a first predetermined threshold;
determining whether the predicted signal strength is greater than the first predetermined threshold;
determining whether the calculated error margin is less than a second predetermined threshold;
determining that the quality of the network is good when the measured signal strength is greater than the first predetermined threshold, the predicted signal strength is greater than the first predetermined threshold, and the calculated error margin is less than the second predetermined threshold; and
determining that the quality of the network is not good when the measured signal strength is not greater than the first predetermined threshold, the predicted signal strength is not greater than the first predetermined threshold, or the calculated error margin is not less than the second predetermined threshold.

13. The method of claim 1, further comprising:
calculating a difference value based on the measured signal strength and a previously measured signal strength; and
determining whether the quality of the network is bad is based on the predicted signal strength at the second point in time, and the difference value.

14. The method of claim 13, where determining whether the quality of the network is bad further comprises:
determining whether the predicted signal strength is less than a third predetermined threshold;
determining whether the calculated difference value is less than a fourth predetermined threshold;
determining that the quality of the network is bad when the predicted signal strength is less than the third predetermined threshold, and the calculated difference value is less than the fourth predetermined threshold; and
determining that the quality of the network is not bad when the predicted signal strength is not less than the third predetermined threshold, or the calculated difference value is not less than the fourth predetermined threshold.

15. The method of claim 1, further comprising:
determining whether a device is currently communicating via the network;
maintaining device communications via the network when it is determined to rove in and when the device is currently communicating via the network;
transitioning device communications to the network when it is determined to rove in and when the device is not currently communicating via the network;
maintaining device communications via a different network when it is determined to rove out and when the device is not currently communicating via the network; and
transitioning device communications to the different network when it is determined to rove out and when the device is currently communicating via the network.

16. The method of claim 15, where the network comprises a wireless local area network and where the different network comprises a cellular-based wireless network.

17. A mobile device, comprising:
a first wireless transceiver for communicating via a first network;
a second wireless transceiver for communicating via a second network;
sensor logic for measuring a signal strength associated with the second network; and
a processor configured to:
receive the measured signal strength associated with a second network at a first point in time;
calculate a predicted signal strength associated with the second network at a second point in time based on the measured signal strength;
determine whether a quality of the second network is good based on the measured signal strength and the predicted signal strength;
determine whether the quality of the second network is bad based on the measured signal strength and the predicted signal strength; and
determine whether to rove in or rove out of the second network based on the determination regarding whether the quality of the second network is good and the determination regarding whether the quality of the second network is bad.

18. The mobile device of claim 17, where the processor is further configured to:
determine whether the device is currently communicating via the second wireless transceiver or the first wireless transceiver;
maintain device communications via the second wireless transceiver when it is determined to rove in and when the device is currently communicating via the second wireless transceiver;
transition device communications from the first wireless transceiver to the second wireless transceiver when it is determined to rove in and when the device is currently communicating via the first wireless transceiver;
maintain device communications via the first wireless transceiver when it is determined to rove out and when the device is currently communicating via the first wireless transceiver; and
transition device communications to the first wireless transceiver when it is determined to rove out and when the device is currently communicating via the second wireless transceiver.

19. The mobile device of claim 17, where the processor is further configured to:
calculate an error margin associated with the predicted signal strength; and
determine whether the quality of the network is good is based on the measured signal strength, the predicted signal strength, and the error margin.

20. A computer-readable memory device including instructions for facilitating transition between a first network and a second network, the instructions comprising:
instructions for measuring a signal strength associated with the second network at a current point in time;
instructions for calculating a predicted signal strength associated with the second network at a second point in time based on the measurement;
instructions for determining whether a quality of the second network is good based on the measured signal strength at the current point in time and the predicted signal strength at the second point in time;
instructions for determining whether the quality of the second network is bad based on the measured signal strength at the current point in time and the predicted signal strength at the second point in time;
instructions for determining whether to communicate via the second network based on the determining whether the quality of the second network is good and the determining whether the quality of the second network is bad; and
transitioning communications into or out of the second network based the determination to communicate via the second network.
